(19) United States
(12) Patent Application Publication
(10) Pub. No.: US 2006/0239866 A1
(43) Pub. Date: Oct. 26, 2006

(54) Glass safety tube

(75) Inventor: James W. Kenney, Broomall, PA (US)

Correspondence Address: JOSEPH M. KONIECZNY, P.C., PO Box 387, CONSHOHOCKEN, PA, 19428-0387, US

(73) Assignee: Drummond Scientific Company, Broomall, PA (US)

(21) Appl. No.: 11/114,624

(22) Filed: Apr. 26, 2005

(51) Int. Cl. B01L 9/00

(52) U.S. Cl. 422/102

(57) ABSTRACT

A glass safety tube with an encapsulating protective safety barrier that contains the glass tube and its contents if the glass tube is fractured. The glass tube has a length L1, an elongate tubular central portion with a diameter D and a length L2, which is less than L1, an open end, and, a closed end portion integrally formed with the central portion and axially extending a distance L3 from the central portion. A first safety barrier envelops the central portion of the glass tube. A second safety barrier envelops the closed end portion of the glass tube.

### FIELD OF THE INVENTION

The present invention relates to glass safety tube that contains an encapsulating protective barrier that contains the glass tube and its contents if the glass tube is fractured or broken.

### BACKGROUND OF THE INVENTION

Traditionally, test tubes and vacuum tubes have been made from glass. However, in recent years, due to the inherent danger of handling infectious fluids in a glass container, plastic test tubes and vacuum tubes have become more popular. While plastic tubes may be safer than glass tubes for handling infectious fluids, many medical professionals still prefer glass tubes for several reasons. For example, plastic vacuum tubes have a tendency to prematurely loose their vacuum. Therefore, it would be desirable to provide a glass tube that is safer for handling fluids of all types.

In order to make glass test tubes and vacuum tubes safer, it has been suggested to wrap the external surface of the glass tube with protective sheeting. However, most inexpensive polymer sheeting lack sufficient strength to encapsulate the glass tube when it fractures or breaks. Further, polymer sheeting does not lay neatly on the closed, bulbous end of the glass tube.

To protect the bulbous, closed end of the tube, it has been suggested to apply a form-fitted, plastic cap. However, a plastic cap is cost prohibitive compared to the cost of mass manufactured glass test tubes or vacuum tubes. Further, since the tolerance is high for such mass produced test tubes and vacuum tubes, a standard plastic cap would likely fail to properly engage a large percentage of such glass tubes. Therefore, it would be desirable to provide a glass safety tube that can be mass produced at a cost comparable to an unprotected glass test tube or vacuum tube.

### SUMMARY OF THE INVENTION

The present invention provides a glass safety tube having an encapsulating protective safety barrier that contains the glass tube and its contents in the event the glass tube is fractured or broken. The safety tube can be mass produced without substantially adding to its cost compared to an unprotected glass test tube or vacuum tube.

The glass tube has an overall length L1, and an elongate tubular central portion with a diameter D and a length L2, which is less than L1. The glass tube has an open end, and a bulbous closed end portion integrally formed with the central portion and axially extending a distance L3 from the central portion. The open end of the glass tube may have an integrally-formed, radially-projecting lip.

A first safety barrier envelops the central portion of the glass tube. The first safety barrier comprises transparent, tear-resistant, polymer sheeting adhered to and wrapped around the central portion. Preferably, the sheeting comprises a heat sealable polyester film that is adhered to the central portion. In the preferred embodiment, the sheeting comprises oven-lidding Mylar®. Preferably, the sheeting does not envelop the lip at the open end of the glass tube.

In a preferred embodiment, one end of the sheeting extends axially past the interface of the central portion and the closed end portion of the glass tube 12. The extension portion does not contact the closed end portion of the glass tube. Rather, the extension portion forms an annular reservoir surrounding the closed end portion.

A second safety barrier envelops the closed end portion of the glass tube. The second safety barrier comprises an adhesive that adheres to the closed end portion of the glass tube and to the extension portion of the sheeting. Preferably, the second safety barrier may comprise a hot melt adhesive, a quick-cure epoxy, or a UV cured adhesive. The adhesive forms a flush interface with the ends of the extension portion.

Other embodiments of glass safety tube are provided. In some alternative embodiments, protection of the closed end portion of the glass tube is reduced or eliminated to reduce the cost of the safety tube.

The present invention also provides a method of making the glass safety tube. In accordance with the method, the glass tube is initially heated. The central portion of the glass tube is then wrapped with the tear-resistant, polymer sheeting. The annular reservoir is formed around the closed end portion by axially extending the sheeting past the interface of the central portion and the closed end portion without contacting the closed end portion.

After the glass tube is wrapped, the glass tube is oriented vertically with the closed end oriented upwardly. The closed end is then enveloped by depositing a fluid adhesive on the closed end, and then allowing the adhesive to cure. The adhesive is contained within the reservoir and prevented from contacting the central portion of the tube. The adhesive forms a flush interface with the end of the sheeting.

### DETAILED DESCRIPTION OF THE DRAWINGS

FIG. 1 is an axial cross-sectional view of a glass safety tube in accordance with an embodiment of the invention;

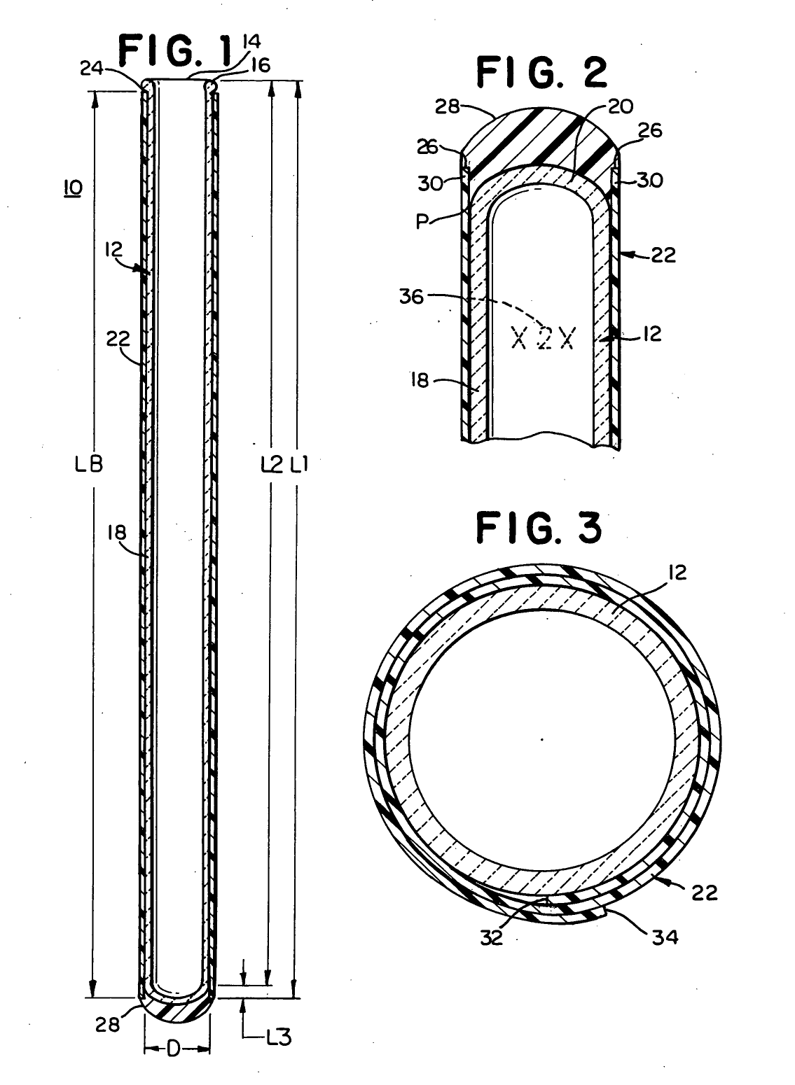

FIG. 2 is an enlarged, fragmentary view of the closed end portion of the glass safety tube of FIG. 1;

FIG. 3 is an enlarged, fragmentary radial cross-sectional view of the glass safety tube of FIG. 1;

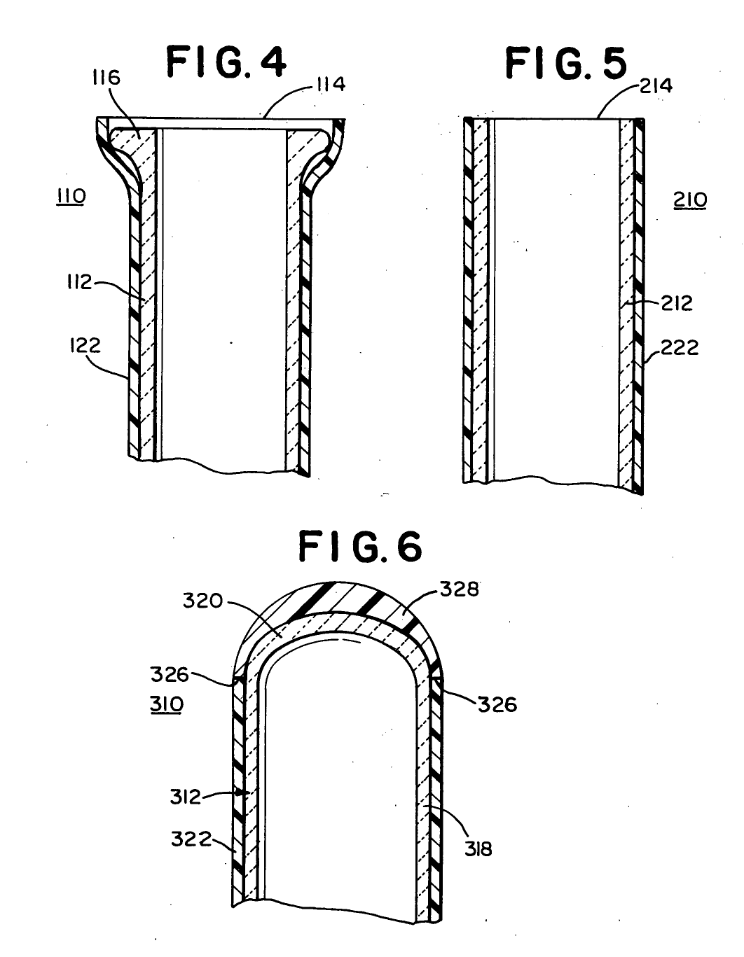

FIG. 4 is a fragmentary, axial cross-sectional view of the open end of a glass safety tube in accordance with a further embodiment of the invention;

FIG. 5 is a fragmentary, axial cross-sectional view of the open end of a glass safety tube in accordance with an additional embodiment of the invention;

FIG. 6 is a fragmentary, axial cross-sectional view of the closed end of a glass safety tube in accordance with yet a further embodiment of the invention;

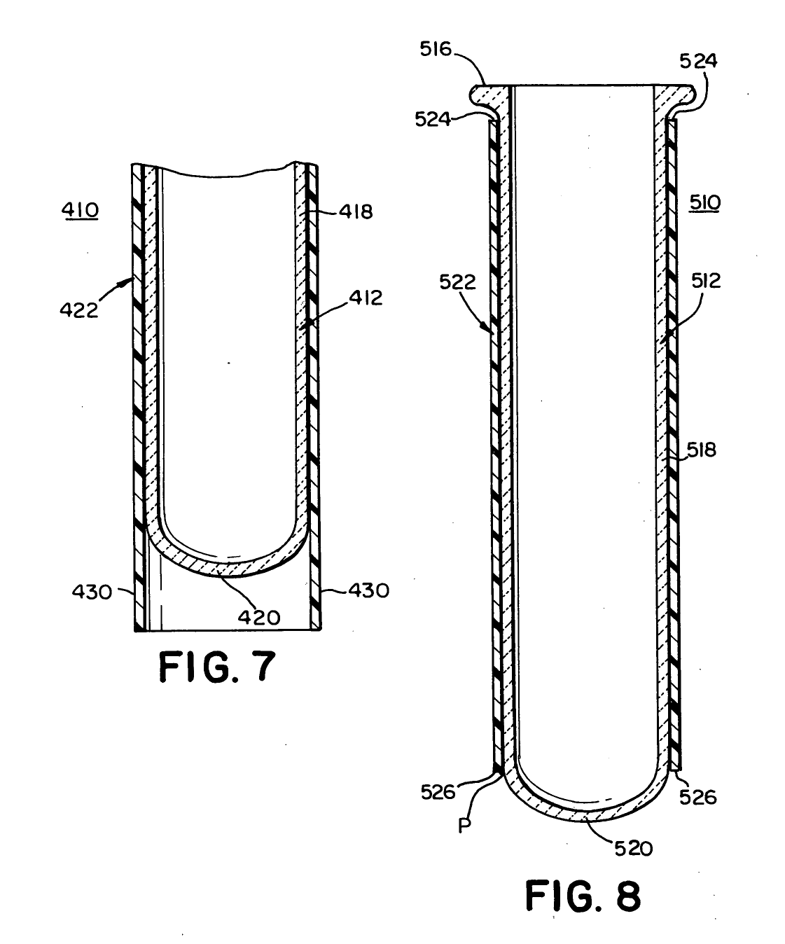

FIG. 7 is a fragmentary, axial cross-sectional view of the closed end of a glass safety tube in accordance with another embodiment of the invention; and,

FIG. 8 is an axial, cross-sectional view of a glass safety tube in accordance with another embodiment of the invention.

### DETAILED DESCRIPTION OF PREFERRED EMBODIMENTS

For the purpose of illustration, there is shown in the accompanying drawings several embodiments of the invention. However, it should be understood by those of ordinary skill in the art that the invention is not limited to the precise arrangements and instrumentalities shown therein and described below. To more clearly illustrate the invention, the drawings are not to scale.

A glass safety tube in accordance with an embodiment of the invention is shown in FIGS. 1-3 and is designated generally by reference numeral 10. Additional embodiments of the invention are illustrated in FIGS. 4-6. Although the invention is described below as a glass safety tube, it should be appreciated by those of ordinary skill in the art that the invention includes other forms of glass safety tubes, such as a safety glass vacuum tube, having one open end and one closed end.

The glass safety tube 10 comprises a glass test tube, designated generally by reference numeral 12, having an open end 14, an elongate, tubular central portion 18, and a generally-bulbous, closed end portion 20 integrally formed with the central portion 18. The open end 14 may also include an integrally-formed, radially-projecting lip 16, which is formed by fire polishing. Referring to FIG. 1, the glass tube 12 has an overall length L1. The central portion has a diameter D and a length L2. The closed end of the tube also has a diameter D and extends axially a distance L3 from the central portion 18 as measured from an interface point P show in FIG. 2. For example, the glass tube may comprise a standard vacuum tube, such as made by Chase Scientific, having the dimensions: L1=11.9 cm; L2=11.8 cm; L3=0.1 cm; and D=0.8 cm. However, it should be understood that a wide variety of different size glass test tubes may be provided without departing from the scope of the present invention.

A first safety barrier envelops the central portion 18 of the glass tube 12. In the embodiment shown in FIGS. 1-3, the first safety barrier comprises tear-resistant, polymer sheeting, designated generally be reference numeral 22, wrapped around and adhered to the central portion 18 of the glass tube 12. Preferably, the sheeting 22 comprises a heat sealable polyester film that is adhered to the central portion 18.

For best results, the sheeting 22 comprises 1.5 mil, oven-lidding Mylar® sold by Dupont Teijin Films. The Mylar® sheeting has an inner adhesive layer and is typically supplied as a non-tacky film sheet with no peelable backing layer. The adhesive becomes tacky at about 200° F. and has excellent adhesive properties.

Referring to FIG. 3, the sheeting 22 is wrapped several times around the central portion 18 beginning with the first radial end 32 adhered to the glass tube 12 and terminating with the second radial end 34 overlaying and adhering to the sheeting 22 itself. The number of times the sheeting 22 is wrapped around the glass tube 12 will depend on the thickness and type of sheeting 22. For example, acceptable results are achieved by wrapping 1.5 mil Mylar® 3 to 4 times around the glass tube 12. The sheeting 22 is wrapped around the central portion 18 of the glass tube 12 so that the adhesive side of the inner layer of sheeting contacts and adheres to the outer surface of the central portion 18. Preferably, at least one additional layer of sheeting 22 is then wrapped over and adhered to the outer surface of the inner layer of sheeting 22.

In the preferred embodiment, the sheeting 22 is adhered to the glass tube 12 by an adhesive that is provided as a layer on the sheeting 22. However, it is within the scope of the present invention to adhere non-adhesive sheeting to the glass tube by first applying a separate adhesive and then applying the non-adhesive sheeting.

The sheeting 22 is preferably clear so that the user can observe the contents of the glass tube 12. If the sheeting 22 is wrinkled or otherwise not laid flay over itself, clarity will be obstructed. To prevent wrinkling, the sheeting preferably does not overlay the radial lip. Instead, the first axial end 24 of the sheeting 22 is applied immediately adjacent the radial lip 16 of the glass tube 12 as best seen in FIG. 1.

Referring to FIGS. 1 and 2, the axial length LB of the sheeting is selected so that a portion 30 of the sheeting extends axially a short distance past the interface of the central portion 18 and the closed end portion 20, designated by reference letter P. It should be appreciated that the interface P is merely a point of reference and not a physical boundary since the closed end portion 20 and central portion 18 are integrally formed. The interface P is designated as the axial location at which the bulbous outer surface of the closed end portion 20 intersects the tubular central portion 18.

As best seen in FIG. 2, the extension portion 30 does not contact the closed end portion 20, but rather extends axially parallel to the walls of the central portion 18. The extension portion 30 forms an annular reservoir surrounding the closed end portion 20 of the glass tube 12. In a preferred embodiment, the extension portion 30 extends at least about 2 mm past the interface P.

A second safety barrier adheres to and envelops the closed end portion 20 of the glass tube 12. In the embodiment shown in FIGS. 1-3, the second safety barrier comprises a curable adhesive 28, which adheres to the closed end portion 20 and the extension portion 30. For ease of production, the adhesive 28 is preferably a quick-cure type such as hot melt adhesive, quick-set epoxy, or UV-cured adhesive. For example, the adhesive may comprise Loctite® 236 hot melt, Loctite® U-09LV urethane, Loctite E-05CL epoxy, or Loctite® 3107 UV. Each of the aforementioned adhesives provides acceptable properties. While hot melt adhesive is the least expensive of the aforementioned materials, UV cured adhesive provides the best clarity.

Referring to FIG. 2, the second barrier is created by depositing a controlled amount of adhesive 28 on the closed end 20 of the glass tube 12. The adhesive 28 collects within the reservoir formed by the extension portion 30 of the sheeting 20. Upon curing, the adhesive adheres to both the closed end 20 of the glass tube 12 and the extension portion 30 of the sheeting 20. The shape of the second safety barrier 22 may be affected by the viscosity of the adhesive and the length of the extension portion 30.

In a preferred embodiment shown in FIG. 2, the axial length LB of the sheeting 22 is less than the length L1 of the glass tube and the length of the extension portion 30 is less than or about equal to the length L3 of the closed end portion 20. In this embodiment, the adhesive 28 forms a flush interface and connection with the second axial end 26 of the sheeting 22.

In the embodiment shown in FIGS. 1-3, the sheeting 22 contains identifying indicia 36 imprinted thereon, which is visible to the user. In the preferred embodiment, clear sheeting is used as the first safety barrier. The identifying indicia 36 can then be imprinted on the portion of the sheeting 22 that forms one of the intermediate layers of the first safety barrier, thereby protecting the identifying indicia 36 from removal, alteration or obstruction.

The sheeting 22 and adhesive 28 generally increase the strength of the glass tube 12 to prevent breakage. Further, the sheeting 22 and adhesive 28 form a very durable encapsulating safety barrier than contains the glass tube and its contents if the glass tube is fractured or broken. Under normal circumstances, the safety barrier remains intact and protects the user from injury or contamination if the glass tube is fractured or broken.

In a preferred embodiment, the safety tube 10 is made by initially providing a glass tube 12 as described above. The glass tube 12 is heated to about 200-275° F. The central portion 18 of the tube is then wrapped with the tear-resistant polymer sheeting 22. The second axial end 26 of the sheeting 22 is extended past the interface P of the central portion 18 and the closed end portion 20, thereby forming an annular reservoir surrounding the closed end portion 20. During wrapping, the glass tube 12 may be oriented vertically or horizontally.

After the glass tube 12 is wrapped, it is oriented vertically with the closed end portion 20 oriented upwardly. The second safety barrier is then formed by depositing a predetermined amount of adhesive 28 on the closed end portion 20 of the glass tube and allowing the adhesive 28 to cure. If hot melt glue is selected as the second safety barrier, the glue should be applied in a circular pattern around the periphery of the reservoir to prevent formation of air pockets in the deepest channels of the reservoir. If epoxy or UV cured adhesives are selected as the second safety barrier, the adhesive may be centrally deposited at the apex of the closed end portion 20. Depending on the adhesive, the curing process may be accelerated by heating.

In a preferred embodiment, the length of the extension portion 30 of the sheeting 22 is less than or about equal to the length L3 of the closed end portion 20. In this embodiment, the amount of adhesive 28 deposited on the glass tube 12 is controlled so that the adhesive does not overflow the reservoir but forms a flush interface with the first axial end 24 of the sheeting 22.

A glass safety tube in accordance with a further embodiment of the invention is shown in FIG. 4 and is designated generally by reference numeral 110. The safety tube 110 comprises a glass test tube 112 identical in construction to the glass test tube 12 described above. The safety tube 110 has a construction similar to the safety tube described above. However, in this embodiment, the tear-resistant, polymer sheeting 122 extends over and envelops the open end 114 of the glass tube 112, including the integrally-formed, radially-projecting lip 116.

A glass safety tube in accordance with an additional embodiment of the invention is shown in FIG. 5 and is designated generally by reference numeral 210. The safety tube 210 comprises a glass test tube 212, similar in construction to the glass test tube 12 described above, but lacking the integrally-formed, radially-projecting lip 16. The safety tube 210 has a construction similar to the safety tube 12 described above. However, in this embodiment, the tear-resistant, polymer sheeting 122 extends over and envelops the entire length of the central portion, including the open end 214 of the glass tube 212.

A glass safety tube in accordance with yet another embodiment of the invention is shown in FIG. 6 and is designated generally by reference numeral 310. The safety tube 310 comprises a glass test tube 312 identical in construction to the glass test tube 12 described above. The safety tube 310 has a construction similar to the safety tube 10 described above. However, in this embodiment, the tear-resistant, polymer sheeting 322 does not extend past the interface of the central portion 318 and the closed end portion 320. In this embodiment, the adhesive 328 of the second safety barrier adheres to the closed end portion 320 and the second axial end 326 of the sheeting 322.

A glass safety tube in accordance with yet another embodiment of the invention is shown in FIG. 7 and is designated generally by reference numeral 410. The safety tube 410 comprises a glass test tube 412 identical in construction to the glass test tube 12 described above.

The safety tube 410 has a construction similar to the safety tube 10 described above. However, in this less expensive embodiment, no second barrier layer is provided on the closed end portion 420 of the glass tube 412 because it is generally the strongest portion of the glass tube 412. Instead, the extension portion 430 of the sheeting 422 extends axially a distance greater than L3 and provides impact protection to the closed end portion 420. The extension portion 430 is elastically deformable and acts like shock absorber in the event the safety tube 410 is dropped or otherwise impacted on the closed end 430. However, the extension portion 430 does not encapsulate the closed end portion 430 if it is fractured or broken. While the closed end portion 420 has no encapsulation or impact protection, the safety tube 410 it is cheaper to manufacture than the embodiment shown in FIGS. 1-3.

A glass safety tube in accordance with yet another embodiment of the invention is shown in FIG. 8 and is designated generally by reference numeral 510. The safety tube 510 comprises a glass test tube 412 identical in construction to the glass test tube 12 described above.

The safety tube 510 has a construction similar to the safety tube 10 described above. However, in this embodiment, no second barrier layer is provided on the closed end portion 420 of the glass tube 412 because it is generally the strongest portion of the glass tube 412. Further, the protective sheeting 522 extends only from immediately adjacent the radial lip 516 to the axial interface P of the central portion 518 and the closed end portion 520 of the glass tube 512. While the closed end portion 520 has no encapsulation or impact protection, the safety tube 510 is cheaper to manufacture than the embodiment shown in FIGS. 1-3.

The embodiments shown in FIGS. 4-5 are made by the first method described above with respect to the first glass safety tube 10. The embodiment shown in FIG. 6 is made in a manner similar to the first method, except that the sheeting 322 is not extended past the interface P of the central portion 18 and the closed end portion 20, and does not form an annular reservoir surrounding the closed end portion 20. The embodiment show in FIG. 7 is made in a manner similar to the first method, except that the extension portion is longer and no adhesive is applied to the closed end portion 420 of the glass tube 412. The embodiment shown in FIG. 8 is made in a manner similar to the first method, except that except that the sheeting 322 is not extended past the interface P of the central portion 18 and the closed end portion 20, and no adhesive is applied to the closed end portion 520 of the glass tube 512.

While the principles of the invention have been described above in connection with specific embodiments, it is to be clearly understood that this description is made only by way of example and not as a limitation on the scope of the invention.

1. A glass safety tube, comprising,
a) a glass tube having
i) a length L1;
ii) an elongate tubular central portion with a diameter D and a length L2, which is less than L1;
iii) an open end; and,
iv) a closed end portion integrally formed with said central portion and axially extending a distance L3 from said central portion;
b) a first safety barrier enveloping said central portion of said glass tube; and
c) a second safety barrier enveloping said closed end portion of said glass tube.

2. The safety tube recited in claim 1, wherein one end of said first safety barrier includes an extension portion that extends axially past the interface of said central portion and said closed end portion.

3. The safety tube recited in claim 2, wherein said extension portion does not contact said closed end portion of said glass tube.

4. The safety tube recited in claim 3, wherein said extension portion forms an annular reservoir surrounding said closed end portion.

5. The safety tube recited in claim 4, wherein said second safety barrier adheres to said closed end portion and to said extension portion.

6. The safety tube recited in claim 4, wherein said first safety barrier is transparent.

7. The safety tube recited in claim 4, wherein said first safety barrier comprises tear-resistant, polymer sheeting wrapped around and adhered to said central portion.

8. The safety tube recited in claim 7, wherein said sheeting comprises a heat sealable polyester film.

9. The safety tube recited in claim 8, wherein said sheeting comprises oven lidding Mylar®.

10. The safety tube recited in claim 5, wherein said second safety barrier comprises a hot melt adhesive.

11. The safety tube recited in claim 5, wherein said second safety barrier comprises a quick-cure epoxy.

12. The safety tube recited in claim 5, wherein said second safety barrier comprises a UV cured adhesive.

13. The safety tube recited in claim 5, wherein said open end has an integrally-formed, radially-projecting lip and said first barrier does not envelop said lip.

14. The safety tube recited in claim 5, wherein said first safety barrier has an axial length LB that is less than L1.

15. The safety tube recited in claim 2, wherein said second safety barrier forms a flush interface with the ends of said extension portion.

16. The safety tube recited in claim 7, wherein said sheeting includes identifying indicia imprinted thereon.

17. A method of making a glass safety tube, comprising the steps of,
a) providing a glass tube having:
i) a length L1;
ii) an tubular central portion with a diameter D and a length L2 that is less than L1;
iii) an open end; and,
iii) a bulbous closed end portion integrally formed with said central portion and axially extending a distance L3 from said central portion;
b) heating the glass tube;
c) enveloping the central portion of the glass tube with a first safety barrier; and
d) enveloping the closed end portion of said glass tube with a second safety barrier.

18. The method recited in claim 17, wherein the central portion of the glass tube is enveloped by wrapping the central portion with tear-resistant, polymer sheeting and adhering the sheeting to the central portion.

19. The method recited in claim 18, wherein the central portion of glass tube is enveloped with a heat sealable polyester film that is adhered to the tubular portion.

20. The method recited in claim 19, wherein the central portion is enveloped with oven-lidding Mylar®.

21. The method recited in claim 20, including the step of forming an annular reservoir surrounding the closed end portion.

22. The method recited in claim 21, wherein the annular reservoir is formed by axially extending the sheeting past the interface of the central portion and the closed end portion without contacting the closed end portion.

23. The method recited in claim 22, wherein the closed end portion is enveloped by orienting the closed end of the glass tube vertically upwardly, depositing a fluid adhesive on the closed end, and then allowing the adhesive to cure.

24. The method recited in claim 23, including the step of preventing the fluid adhesive from contacting the central portion of the tube by containing the fluid adhesive in the reservoir.

25. The method recited in claim 24, including the step of forming a flush interface between the adhesive and the end of the sheeting.

26. A glass safety tube, comprising,
a) a glass tube having a tubular central portion, an open first end, and a closed second end; and,
b) Mylar® sheeting adhered to and wrapped around the central portion of said glass tube; and,
c) an adhesive adhered to the closed end of said glass tube and a portion of said Mylar® sheeting;
wherein said sheeting and adhesive form an encapsulating safety barrier that contains the glass tube and its contents if the glass tube is fractured or broken.

27. A glass safety tube, comprising,
a) a glass tube having
i) a length L1;
ii) an elongate tubular central portion with a diameter D and a length L2, which is less than L1;
iii) an open end; and,
iv) a closed end portion integrally formed with said central portion and axially extending a distance L3 from said central portion; and,
b) a safety barrier enveloping said central portion of said glass tube, said safety barrier including an extension portion that extends axially past the interface of said central portion and said closed end portion.

28. The safety tube recited in claim 28, wherein said extension portion does not contact said closed end portion of said glass tube.

29. The safety tube recited in claim 28, wherein said extension portion forms an annular reservoir surrounding said closed end portion.

30. The safety tube recited in claim 27, wherein said first safety barrier is transparent.

31. The safety tube recited in claim 27, wherein said safety barrier comprises tear-resistant, polymer sheeting wrapped around and adhered to said central portion.

32. The safety tube recited in claim 31, wherein said sheeting comprises a heat sealable polyester film that is adhered to said central portion.

33. The safety tube recited in claim 32, wherein said sheeting comprises oven lidding Mylar®.

34. The safety tube recited in claim 31, wherein said sheeting includes an inner layer wrapped around and adhered to said central portion and an outer layer adhered to and overlaying the inner layer.

35. The safety tube recited in claim 27, wherein said extension is elastically deformable.

36. A glass safety tube, comprising,
a) a glass tube having
i) a length L1;
ii) an elongate tubular central portion with a diameter D and a length L2, which is less than L1;
iii) an open end; and,
iv) a closed end portion integrally formed with said central portion and axially extending a distance L3 from said central portion, said closed end portion and said central portion interfacing at an axial location P; and,
b) a safety barrier enveloping said central portion of said glass tube, said safety barrier comprising a sheet of tear-resistant, polymer sheeting wrapped around and adhered to said central portion, said sheet extending from said axial interface location P to at least the axial location immediately adjacent the open end of said glass tube.

37. The safety tube recited in claim 36, wherein said sheeting comprises a heat sealable polyester film.

38. The safety tube recited in claim 37, wherein said sheeting comprises oven lidding Mylar®.
